(19) United States
(12) Patent Application Publication
(10) Pub. No.: US 2007/0127791 A1
(43) Pub. Date: Jun. 7, 2007

(54) Automated synchronization of 3-D medical images, related methods and computer products

(75) Inventors: Aron Ernvik, Linkoping (SE); Anders Brodin, Linkoping (SE)

Correspondence Address: MYERS BIGEL SIBLEY & SAJOVEC, PO BOX 37428, RALEIGH, NC, 27627, US

(73) Assignee: Sectra AB

(21) Appl. No.: 11/273,849

(22) Filed: Nov. 15, 2005

(51) Int. Cl. G06K 9/00

(52) U.S. Cl. 382/128

(57) ABSTRACT

Methods, systems and computer programs can electronically provide a visual comparison of rendered 3-D medical images. The methods include: (a) providing first and second 3-D medical digital images of a patient on at least one display; (b) electronically altering a visualization of the first 3-D image on the at least one display; and (c) automatically electronically synchronizing visualization of the second 3-D image responsive to the altering of the first 3-D image.

### FIELD OF THE INVENTION

The present invention relates to medical renderings of imaging data.

### RESERVATION OF COPYRIGHT

A portion of the disclosure of this patent document contains material to which a claim of copyright protection is made. The copyright owner has no objection to the facsimile or reproduction by anyone of the patent document or the patent disclosure, as it appears in the Patent and Trademark Office patent file or records, but reserves all other rights whatsoever.

### BACKGROUND OF THE INVENTION

Three-dimensional (3-D) visualization products for medical images can primarily employ a visualization technique known Direct Volume Rendering (DVR). The data input used to create the image renderings can be a stack of image slices from a desired imaging modality, for example, a Computed Tomography (CT) or Magnetic Resonance (MR) modality. DVR can convert the image data into an image volume to create renderings, such as the one shown in FIG. 1.

Direct Volume Rendering (“DVR”) has been used in medical visualization research for a number of years. DVR can be generally described as rendering visual images directly from volume data without relying on graphic constructs of boundaries and surfaces thereby providing a fuller visualization of internal structures from 3-D data. DVR holds promise for its diagnostic potential in analyzing medical image volumes. Slice-by-slice viewing of medical data may be increasingly difficult for the large data sets now provided by imaging modalities raising issues of information and data overload and clinical feasibility with current radiology staffing levels. See, e.g., Adressing the Coming Radiology Crisis: The Society for Computer Applications in Radiology Transforming the Radiological Interpretation Process (TRIP™) Initiative, Andriole et al., at URL scarnet.net/trip/pdf/TRIP_White_Paper.pdf (November 2003). In some modalities, patient data sets can have large volumes, such as greater than 1 gigabyte, and can even commonly exceed 10's or 100's of gigabytes.

The diagnostic task of a clinician such as a radiologist may include comparisons with similar images. In some situations, a clinician wants to compare an image with previous examinations of the same patient, to determine, for example, whether the findings are a normal variant or signs of a progressing disease. In other situations, a clinician may want to compare images resulting from examinations using different imaging modalities.

### SUMMARY OF EMBODIMENTS OF THE INVENTION

Embodiments of the present invention are directed to methods, systems and computer program products that automatically synchronize views in different 3-D medical images. That is, embodiments of the invention can be carried out so that substantially the exact same visualization and/or rendering operation can be electronically automatically applied to two or more views at once.

Methods, systems and computer programs can electronically provide a visual comparison of rendered 3-D medical images. The methods include: (a) providing first and second 3-D medical digital images of a patient on at least one display; (b) electronically altering a visualization of the first 3-D image on the at least one display; and (c) automatically electronically synchronizing visualization of the second 3-D image responsive to the altering of the first 3-D image.

Other embodiments are directed to methods that synchronize diagnostic images for a clinician. The methods include: (a) displaying a first 3-D image of a target region of a patient; (b) displaying a second 3-D image of the same target region of the patient taken at a different time or from a different imaging modality, the second image being obtained from electronic memory, wherein the second image is displayed proximate the first image; (c) electronically manipulating visualization of the first 3-D image; and (d) automatically electronically synchronizing an altered visualization of the second 3-D image to substantially concurrently display with the same visualization as the manipulated visualization of the first 3-D image.

Other embodiments are directed to visualization systems having 3-D medical image synchronization. The systems include: (a) a rendering system configured to generate 3-D medical images from respective digital medical volume data sets of one or more patients; (b) a first display in communication with the rendering system configured to display a first 3-D medical image generated by the rendering system, the first 3-D image associated with a first medical volume data set of a patient; (c) a second display in communication with the rendering system configured to display a second 3-D medical image of the patient, the second 3-D image associated with a second different medical volume data set of the patient; (d) a physician workstation comprising a graphic user interface (GUI) in communication with the first 3-D medical image on the first display to allow a physician to interactively alter the first 3-D image; and (e) a signal processor comprising a 3-D synchronization module in communication with the physician workstation, the 3-D synchronization module configured to synchronize the 3-D image on the second display with that of the 3-D image on the first display based on a physician's interactive input of a desired view of the patient.

In some embodiments, the synchronization module may be configured to programmatically (a) alter a transfer function parameter (b) segment and (c) sculpt to alter a view of the first image and substantially concurrently electronically alter a view of the second image in the same manner.

Still other embodiments are directed to computer program products for providing physician interactive access to patient medical volume data for generally concurrently rendering a plurality of related 3-D diagnostic medical images. The computer program product includes a computer readable storage medium having computer readable program code embodied in the medium. The computer-readable program code including: (a) computer readable program code configured to generate first and second 3-D medical digital images of a patient on at least one display; (b) computer readable program code configured to alter a visualization of the first 3-D image on the at least one display; and (c) computer readable program code configured to synchronize visualization of the second 3-D image responsive to the altering of the first 3-D image.

Some embodiments are directed to signal processor circuits that include a 3-D synchronization module in communication with a physician workstation. The 3-D synchronization module is configured to synchronize a 3-D image of a patient on a second display with that of a corresponding 3-D image of the patient on a first display, based on a physician's interactive input of a desired view of the patient using the first display.

Other embodiments are directed to signal processor circuits that include a 3-D synchronization module in communication with a physician workstation. The 3-D synchronization module configured to synchronize a 3-D image of a patient on a second display with that of a corresponding 3-D image of the patient on a first display, based on a sequence of views defined by a visualization algorithm corresponding to a defined diagnosis or medical condition review protocol.

In some embodiments a combined interactive and rules-based 3-D synchronization module can be provided.

It is noted that any of the features claimed with respect to one type of claim, such as a system, apparatus, or computer program, may be claimed or carried out as any of the other types of claimed operations or features.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a screen shot of a DVR 3-D image of a head of a patient.

FIG. 2 is a block diagram of an electronic visualization pipeline that can be used to render and display synchronized 3-D images according to embodiments of the present invention.

FIG. 3A is a block diagram schematic illustration of a non-synched viewing technique.

FIG. 3B is a block diagram of an exemplary synched viewing technique according to embodiments of the present invention.

FIG. 4 are screen shots of side-by-side synchronized 3-D images of a patient according to embodiments of the present invention.

FIG. 5 is a flow chart of operations that can be carried out according to embodiments of the present invention.

FIG. 6 is a block diagram of a data processing system according to embodiments of the present invention.

FIG. 7 is a schematic illustration of exemplary synching operations that can be electronically automatically carried out according to embodiments of the present invention.

FIG. 8 is a schematic illustration of groups of 3-D images that can allow synchronization to be applied to other members of that group according to embodiments of the present invention.

FIGS. 9A, 9B, 10A, 10B, 11A, 11B, 12A, 12B, 13A and 13B are screen shots illustrating an exemplary synch operations according to embodiments of the present invention.

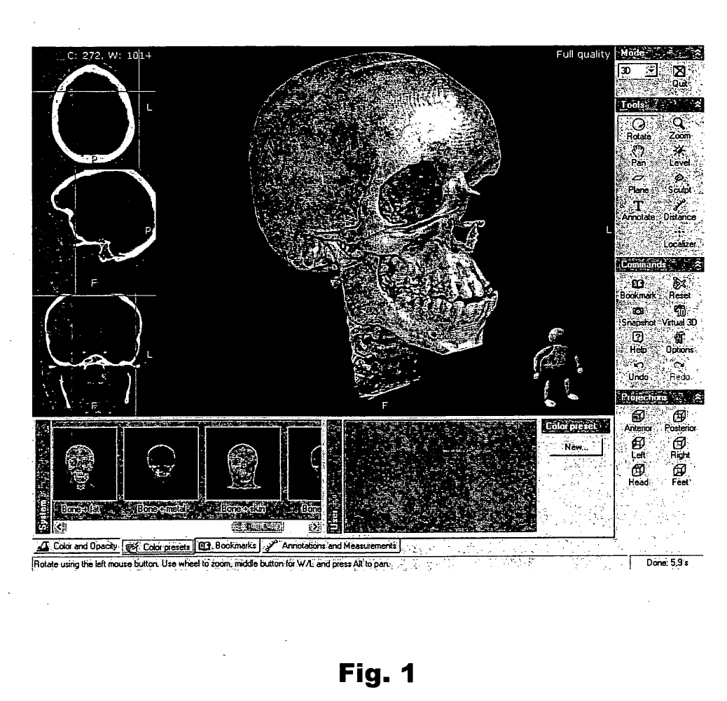

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. In the claims, the claimed methods are not limited to the order of any steps recited unless so stated thereat.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers,-steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

The term “Direct Volume Rendering” or DVR is well known to those of skill in the art. DVR comprises electronically rendering a medical image directly from volumetric data sets to thereby display visualizations of target regions of the body, which can include color as well as internal structures, using volumetric and/or 3-D data. In contrast to conventional iso-surface graphic constructs, DVR does not require the use of intermediate graphic constructs (such as polygons or triangles) to represent objects, surfaces and/or boundaries. However, DVR can use mathematical models to classify certain structures and can use graphic constructs.

Also, although embodiments of the present invention are directed to DVR of medical images, other 3-D image generation techniques and other 3-D image data may also be used. That is, the 3-D images with respective visual characteristics or features may be generated differently when using non-DVR techniques.

The term “automatically” means that the operation can be substantially, and typically entirely, carried out without human or manual input, and is typically programmatically directed or carried out. The term “electronically” includes both wireless and wired connections between components.

The term “clinician” means physician, radiologist, physicist, or other medical personnel desiring to review medical data of a patient. The term “tissue” means blood, cells, bone and the like. “Distinct or different tissue” or “distinct or different material” means tissue or material with dissimilar density or other structural or physically characteristic. For example, in medical images, different or distinct tissue or material can refer to tissue having biophysical characteristics different from other (local) tissue. Thus, a blood vessel and spongy bone may have overlapping intensity but are distinct tissue. In another example, a contrast agent can make tissue have a different density or appearance from blood or other tissue.

The term “transfer function” means a mathematical conversion of volume data to image data that typically applies one or more of color, opacity, intensity, contrast and brightness. The transfer function is usually connected to the intensity scale rather than spatial regions in the volume. See also, co-pending, co-assigned U.S. patent application Ser. No. 11137160, entitled, Automated Medical Image Visualization Using Volume Rendering with Local Histograms, and Ljung et al., Transfer Function Based Adaptive Decompression for Volume Rendering of Large Medical Data Sets, Proceedings IEEE Volume Visualization and Graphics Symposium (2004), pp. 25-32, the contents of which are hereby incorporated by reference as if recited in full herein.

The term “synchronization” and derivatives thereof means that the same operation is applied to two or more views generally, if not substantially or totally, concurrently. Synchronization is different from registration, where two volumes are merely aligned. The synchronization operation can be carried out between at least two different 3-D images, where an operation on a first image is automatically synchronized (applied) to the second image. It is noted that there can be any number of views in a synch group. Further, the synchronization does not require a static “master-slave” relationship between the images. For example, if an operation on image 1 is synched to image 2, then an operation on image 2 can also be synched to image 1 as well. In addition, in some embodiments, there can be several synch groups defined, and the synch operation can be applied across all groups, between defined groups, or within a single group, at the same time. For example, a display can have three groups of 3-D images, each group including two or more 3-D images, and the synch operation can be applied to images within a single group based on a change to one of the 3-D images in that group. Alternatively, the synch may be applied to images in other groups as well as to images within the group that the changed image belongs.

Visualization means to present, in 2-D what appears to be 3-D images, volume data representing features with different visual characteristics such as with differing intensity, opacity, color, texture and the like. Thus, the term “3-D” in relation to images does not require actual 3-D viewability (such as with 3-D glasses), just a 3-D appearance on a display. The term “similar examination type” refers to corresponding anatomical regions or features in images having diagnostic or clinical interest in different data sets corresponding to different patients (or the same patient at a different time). For example, but not limited to, a coronary artery, organs, such as the liver, heart, kidneys, lungs, brain, and the like.

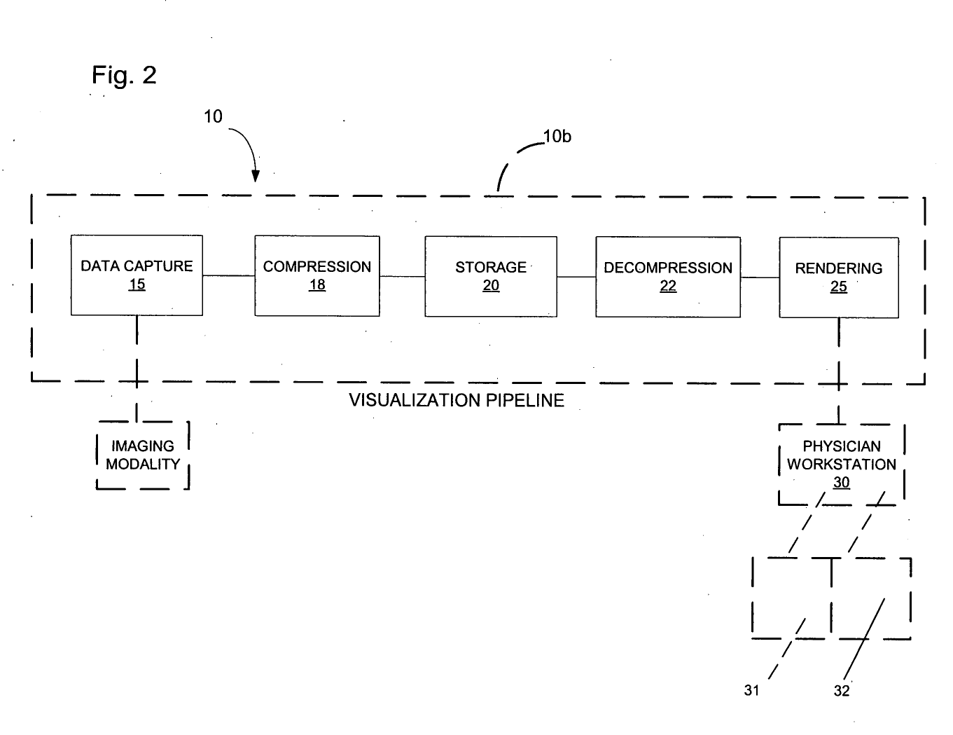

Turning now to FIG. 2, a visualization pipeline 10 is illustrated. As known to those of skill in the art and as shown by the broken line box 10b, the pipeline 10 can include a data capture circuit 15, a compression circuit 18, a storage circuit 20, a decompression circuit 22 and a rendering system 25. The visualization pipeline 10 can be in communication with at least one imaging modality 50 that electronically obtains respective volume data sets of patients and can electronically transfer the data sets to the data capture circuit 15. The imaging modality 50 can be any desirable modality such as, but not limited to, NMR, MRI, X-ray of any type, including, for example, CT (computed tomography) and fluoroscopy, ultrasound, and the like. The visualization system 10 may also operate to render images using data sets from more than one of these modalities. That is, the visualization system 10 may be configured to render images irrespective of the imaging modality data type (i.e., a common system may render images for both CT and MRI volume image data). In some embodiments, the system 10 may optionally combine image data sets generated from different imaging modalities 50 to generate a combination image for a patient.

As shown in FIG. 2, the rendering system 25 may be in communication with a physician workstation 30 to allow user input (typically graphical user input (“GUI”) and interactive collaboration of image rendering to give the physician the image views of the desired features in generally, typically substantially, real time. The rendering system 25 can be configured to zoom, rotate, and otherwise translate to give the physician visualization of the patient data in numerous views, such as section, front, back, top, bottom, and perspective views. The rendering system 25 may be wholly or partially incorporated into the physician workstation 30, but is typically a remote or local module, component or circuit that can communicate with a plurality of physician workstations (not shown). The visualization system can employ a computer network and may be particularly suitable for clinical data exchange/transmission over an intranet. A respective workstation 30. can include at least one display, shown as two adjacent displays 31, 32.

The rendering system 25 can include a DVR image processor system. The image processor system can include a digital signal processor and other circuit components that allow for collaborative user input as discussed above. Thus, in operation, the image processor system renders the visualization of the medical image using the medical image volume data, typically on at least one display at the physician workstation 30.

In some embodiments, a first display 31 may be the master display with, for example, GUI input, and the other display 32 may be a slave display that cooperates with commands generated using the master display to generate common visualizations of a related but different 3-D image synchronized with that on the first display 31. In other embodiments, each display can act as either a master or slave and an electronic activate switch or icon can allow a clinician to electronically tie the two displays together for synchronization of the rendered images. Additional displays may also be synched with the first and/or second displays 31, 32 (not shown).

In other embodiments, two synchronized 3-D images can be displayed on a single display at a workstation 30. In some embodiments, one image can function as the master image and the other image can be the slave image that is rendered responsive to and using the same visualization tools or data manipulation operations used to create the selected view of the first image.

In some embodiments, instead of clinician input, an electronic module (that can be automatically programmatically carried out) employing rules-based visualization (segmentation, zoom, sculpting, etc) of two or more 3-D images can be used to generate the different synchronized views of the two or more 3-D images. The rules-based algorithm can be predefined to generate a sequence of views and the views can depend on the examination underway, a diagnosis and/or or can be selected using a pull-down chart or list of certain pre-configured sequences of views.

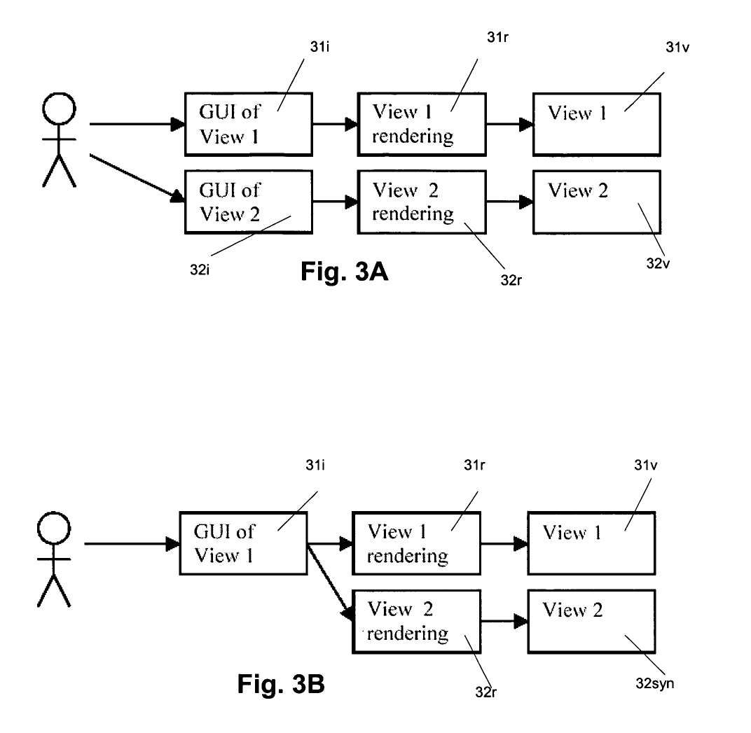

FIG. 3A illustrates that while working with the 3-D images, a user typically manipulates the visualization in a number of ways. For example, the image volume may be rotated and zoomed, the settings of color and opacity (the Transfer Function) is changed, etc. FIG. 3A illustrates that a user can obtain a comparison of images by using a GUI interface, 31i, 32i to manipulate the image on each display, which is then respectively rendered 31r, 32r to generate common views 31v, 32v.

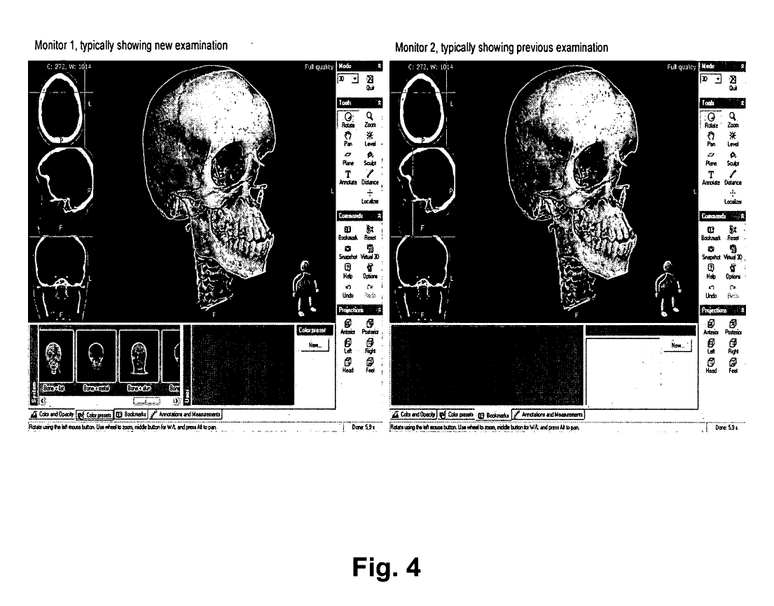

FIG. 3B illustrates that embodiments of the present invention can automatically electronically synchronize two or more 3D views, i.e. that, when in synch mode, substantially any operation (input from one display 31i or generated using an automatic rules-based algorithm) made for one view 31v is automatically applied to the other 32syn. The operations that can be automatically synched include, but are not limited to, rotation, zoom, Transfer Function change, and sculpting/cut planes (removing parts of the volume from the view). An example how synchronized display views may look is shown in FIG. 4. Table 1 below illustrates exemplary differences between some typical 2-D sync operations and 3-D synch operations. The “change reference point” can be used to determine, e.g., which slicing 2-D images to show next to the 3-D image.

TABLE 1
Exemplary Synch Operations

| TYPICAL 2D SYNC | |
|---|---|
| OPERATION | TYPICAL 3D SYNC OPERATION |
| ZOOM | ZOOM |
| WINDOW/LEVEL SETTING | TRANSFER FUNCTION CHANGE |
| STACK BROWSING/CINE | ROTATION, CHANGE REFERENCE |
| LOOP | POINT |
| PAN | PAN |
| CROPPING | SCULPTING/CUT PLANE |
| | SEGMENTATION |

FIG. 4 illustrates synchronized 3-D images can be displayed on two adjacent screens or displays. However, as noted above, the two or more synchronized 3-D images may also be displayed on a common screen with different partitions of display (upper half, lower half, side by side or other partition segments).

FIG. 4 also illustrates that several two-dimensional (2-D) images related to the 3-D images can be displayed. The 2-D images can also be synchronized to change in response to the selected rendering/visualization of the view of the corresponding 3-D image.

FIG. 4 illustrates that one display (the screen shot on the left) can display images from a new examination while the other display (the screen shot on the right) can display a previous examination. In other embodiments, images of different persons can be compared. Each screen can include selectable electronic tools, commands, and image projection selections. A tool bar proximate an outer perimeter edge portion (shown at the bottom) can be used for color, opacity and the like. An input tool such as a mouse can be used to carry out several of the operations concurrently (such as rotating while zooming or panning). Manipulating the visualization on one display can be carried out so that the view on the second display follows along synchronized substantially concurrently based on actions taken on the image data on the first display.

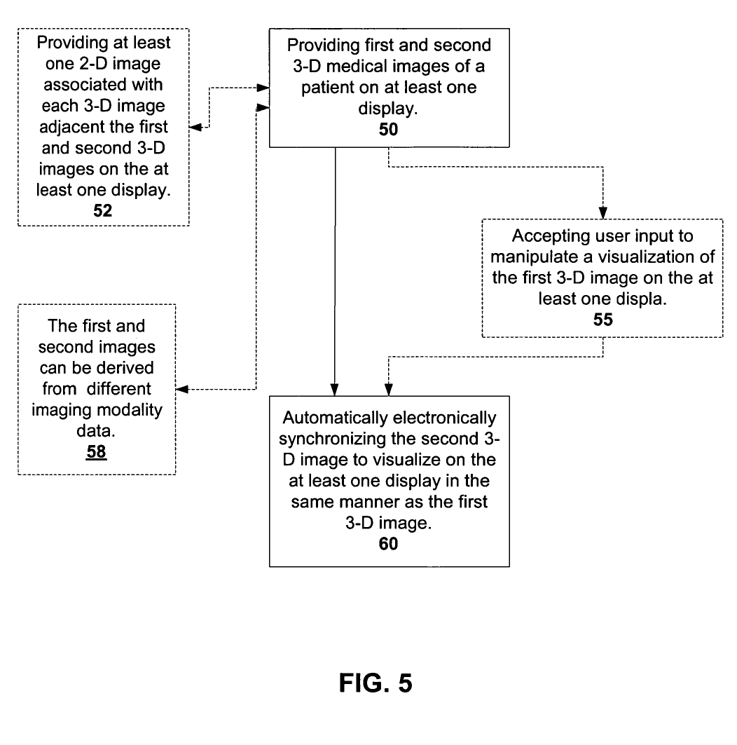

FIG. 5 illustrates exemplary operations that can be used to synchronize the display of two different 3-D images taken from different volume data sets. First and second 3-D medical images of a patient can be provided on at least one display (block 50). The second 3-D image can be automatically electronically synchronized to have the same substantially the visualization (display, appear or present in the same view) on the at least one display as the first 3-D image (block 60). That is, some slight different visual characteristics (or a text header, different background, etc. . . . ) may be used in the first or second visualization (for example, intensity), but the differences should be such that it does not impair the clinician's visual comparison of the two.

In some embodiments, user input can be accepted to manipulate a visualization of the first 3-D image on the at least one display (block 55). Also, optionally, at least one 2-D image associated with the 3-D image can be provided adjacent the respective first and second 3-D images on the at least one display (block 52). The first and second images can be generated using different imaging modality data sets (block 58). For example, the first 3-D image can be a CT image and the second 3-D image can be an MRI image. The associated 2-D images can also be derived from different imaging modality data than the corresponding 3-D data of a patient.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic or other electronic storage devices.

Computer program code for carrying out operations of the present invention may be written in an object oriented programming language such as Java, Smalltalk or C++. However, the computer program code for carrying out operations of the present invention may also be written in conventional procedural programming languages, such as the “C” programming language or in a visually oriented programming environment, such as VisualBasic.

Certain of the program code may execute entirely on one or more of the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). In some embodiments, some program code may execute on local computers and some program code may execute on one or more local and/or remote server. The communication can be done in real time or near real time or off-line using a volume data set provided from the imaging modality.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

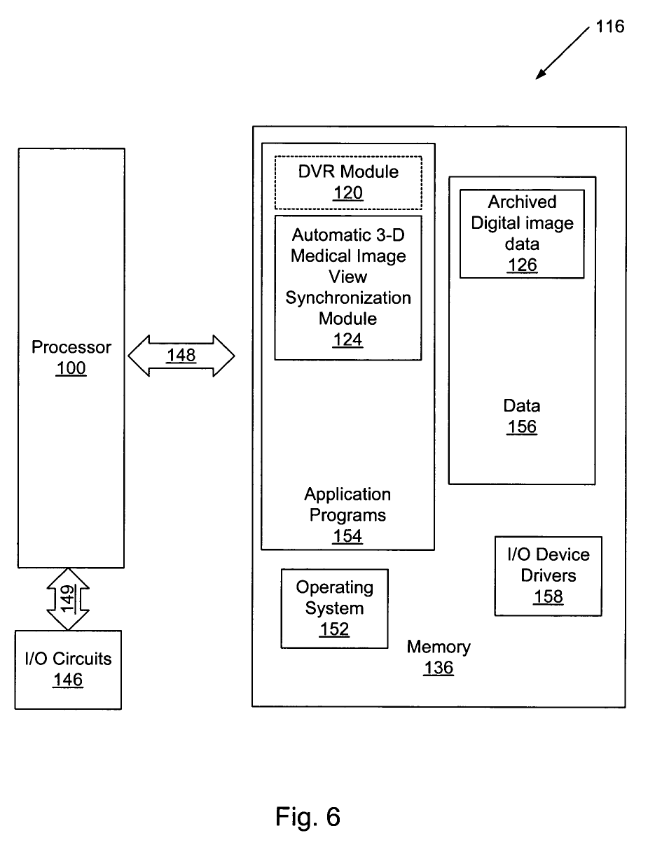

As illustrated in FIG. 6, embodiments of the invention may be configured as a data processing system 116, which can be used to carry out or direct operations of the rendering, and can include a processor circuit 100, a memory 136 and input/output circuits 146. The data processing system may be incorporated in, for example, one or more of a personal computer, workstation, server, router or the like. The processor 100 communicates with the memory 136 via an address/data bus 148 and communicates with the input/output circuits 146 via an address/data bus 149. The input/output circuits 146 can be used to transfer information between the memory (memory and/or storage media) 136 and another computer system or a network using, for example, an Internet protocol (IP) connection. These components may be conventional components such as those used in many conventional data processing systems, which may be configured to operate as described herein.

In particular, the processor 100 can be commercially available or custom microprocessor, microcontroller, digital signal processor or the like. The memory 136 may include any memory devices and/or storage media containing the software and data used to implement the functionality circuits or modules used in accordance with embodiments of the present invention. The memory 136 can include, but is not limited to, the following types of devices: ROM, PROM, EPROM, EEPROM, flash memory, SRAM, DRAM and magnetic disk. In some embodiments of the present invention, the memory 136 may be a content addressable memory (CAM).

As further illustrated in FIG. 6, the memory (and/or storage media) 136 may include several categories of software and data used in the data processing system: an operating system 152; application programs 154; input/output device drivers 158; and data 156. As will be appreciated by those of skill in the art, the operating system 152 may be any operating system suitable for use with a data processing system, such as IBM®, OS/2®, AIX® or zOS® operating systems or Microsoft® Windows®95, Windows98, Windows2000 or WindowsXP operating systems Unix or Linux™. IBM, OS/2, AIX and zOS are trademarks of International Business Machines Corporation in the United States, other countries, or both while Linux is a trademark of Linus Torvalds in the United States, other countries, or both. Microsoft and Windows are trademarks of Microsoft Corporation in the United States, other countries, or both. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents the static and dynamic data used by the application programs 154 the operating system 152 the input/output device drivers 158 and other software programs that may reside in the memory 136.

The data 156 may include (archived or stored) digital volumetric image data sets 126 that provides stacks of image data correlated to respective patients. As further illustrated in FIG. 6, according to some embodiments of the present invention application programs 154 include one or more of: a DVR Module 120, an automatic (automatic including semi-automatic) 3-D Medical Image View Synchronization Module 124. The application programs 120, 124 may be located in a local server (or processor) and/or database or a remote server (or processor) and/or database, or combinations of local and remote databases and/or servers.

While the present invention is illustrated with reference to the application programs 154, 120, 124 in FIG. 6, as will be appreciated by those of skill in the art, other configurations fall within the scope of the present invention. For example, rather than being application programs 154 these circuits and modules may also be incorporated into the operating system 152 or other such logical division of the data processing system. Furthermore, while the application programs 120, 124 are illustrated in a single data processing system, as will be appreciated by those of skill in the art, such functionality may be distributed across one or more data processing systems. Thus, the present invention should not be construed as limited to the configurations illustrated in FIG. 6, but may be provided by other arrangements and/or divisions of functions between data processing systems. For example, although FIG. 6 is illustrated as having various circuits and modules, one or more of these circuits or modules may be combined or separated without departing from the scope of the present invention.

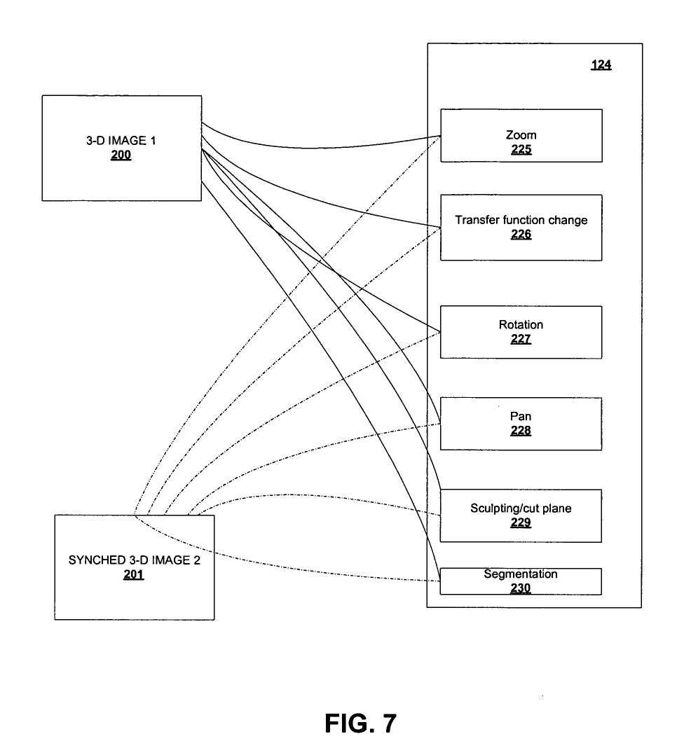

FIG. 7 is a schematic illustration of a rendering system that synchronizes different images according to embodiments of the present invention. As shown two different 3-D images can be displayed 200, 201. As one or more of the tools shown as blocks 225-230 are applied to the first image 200 (as shown by the solid lines) they are automatically electronically applied (as shown by the broken line) to render the second image 201. The tools 225-230 can be in different circuits or can be held in or directed by a synchronization module 124.

The tools listed in FIG. 7 can include a sculpting tool 229. Sculpting can be performed to cut planes. Sculpting can also be deployed using arbitrarily shaped regions. In the latter situation, a user typically draws an area on the screen to indicate the sculpted region of interest. The GUI input can then partition the data to render an image of the sculpted region. The tool set shown in FIG. 7 also includes segmentation 230, which is a tool used to, in some way, separate objects from each other. One example is to select and remove the scull bone in order to see the brain. A typical implementation is to let the user place a “seed” that grows and connects all (or substantially all) voxels with similar intensity in one object. Segmentation is mostly used to remove things, and can in that case be considered a sculpting tool, but it can be used for other purposes, e.g., to measure volumes.

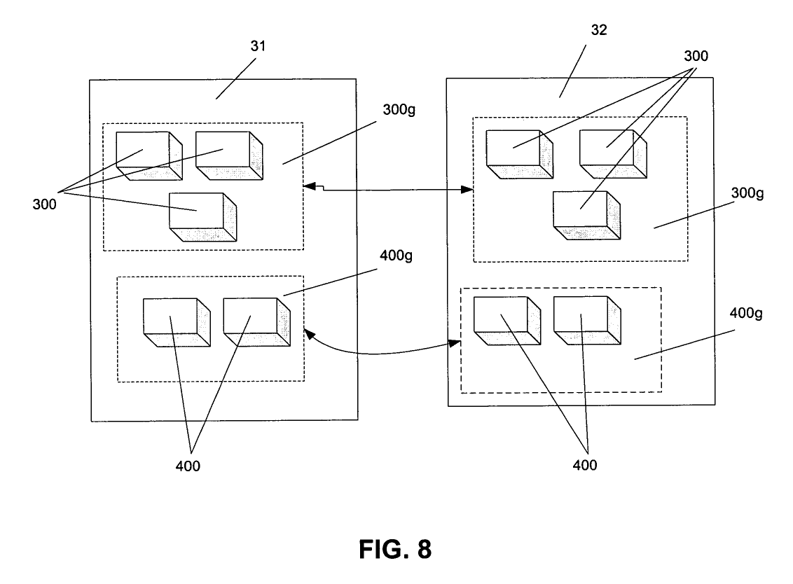

FIG. 8 illustrates that in some embodiments, groups of 3-D images may be defined or electronically related. As shown, there are two groups 300g, 400g but one or more than two groups may also be used. As also shown, the two groups 300g, 400g have a different number of group members 300 (shown as three), 400 (shown as two), respectively. Lesser or greater numbers of members may be used in the defined groups (such as one or more than three). Also, as shown, the respective members 300, 400 are displayed in spatially related clusters of group members. However, the respective group members can be spaced apart or placed between or adjacent members of other groups. In some embodiments, a manipulation can be initiated on a first member image within a first group and the synchronization can be automatically applied to only the other image members of that group on each display 31, 32 or display segments (where a single display is used). Alternatively, a change on one member of one group can cause synchronization to occur to its group member images and to members of one or more other groups.

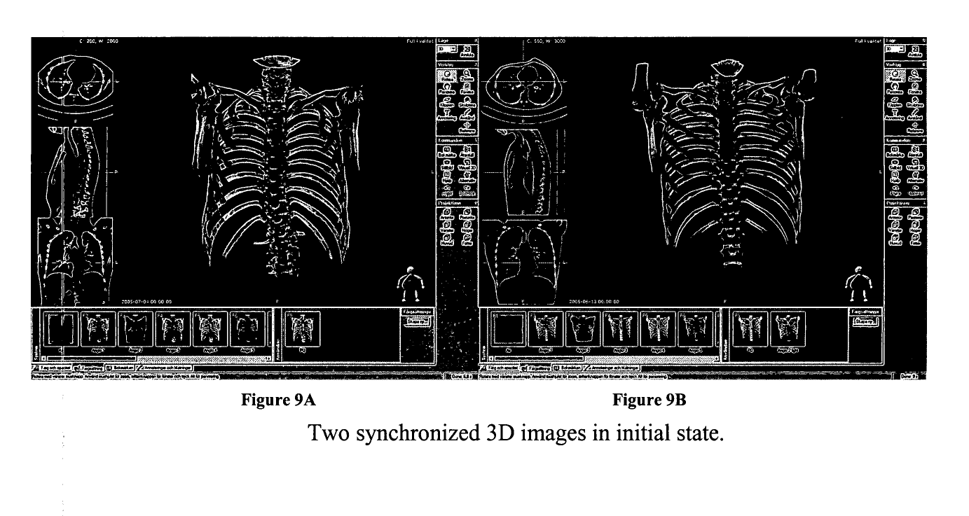

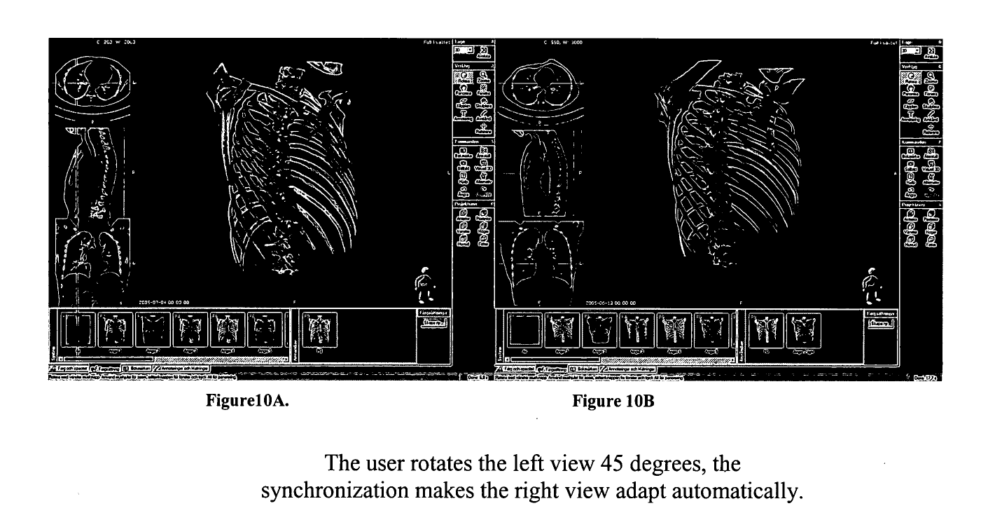

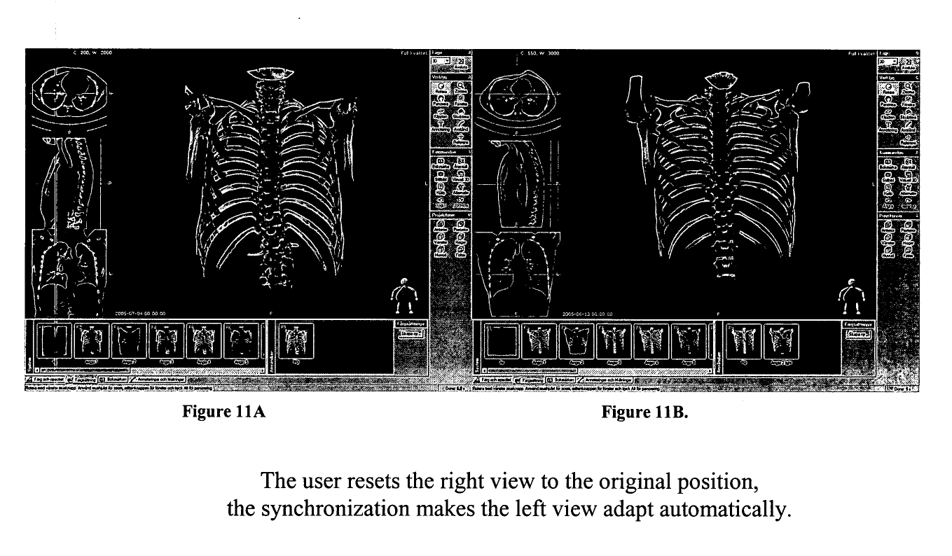

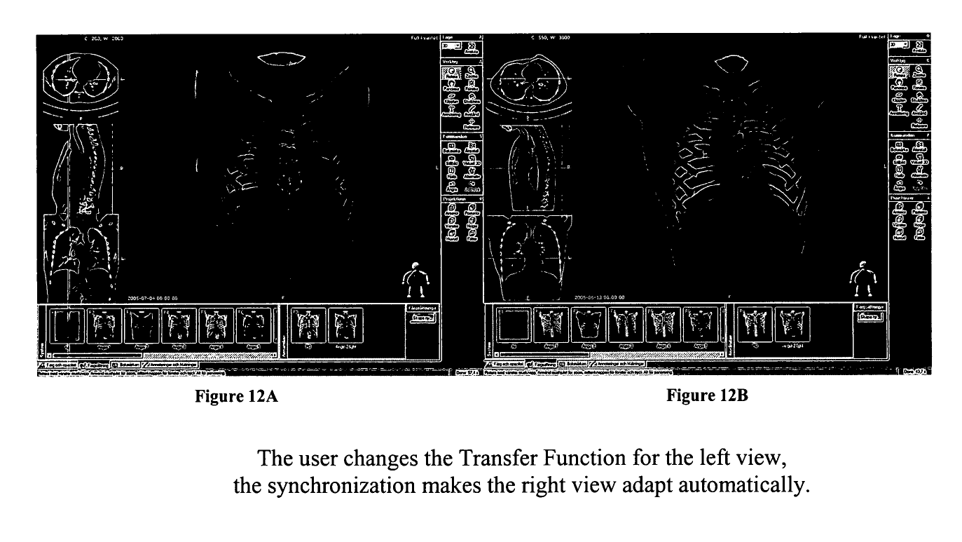

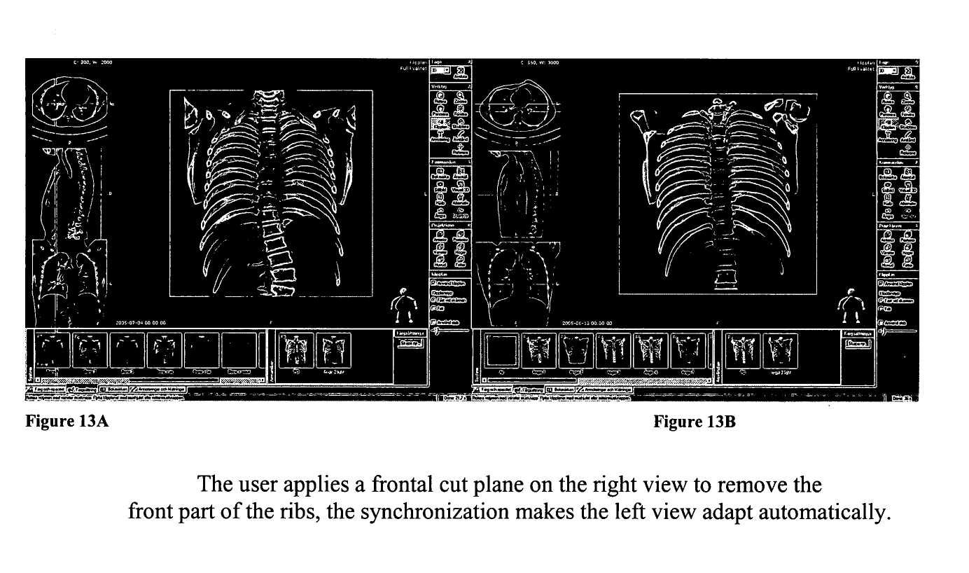

FIGS. 9A and 9B illustrate two synchronized 3-D images in an exemplary initial state. FIG. 10A illustrates that as a user rotates the left view 45 degrees, the synchronization makes the right view shown in FIG. 10B, adapt automatically. FIGS. 11A and 11B show that a user can reset the right view (FIG. 11B) to the original position, the synchronization makes the left view (FIG. 11A) adapt automatically. FIGS. 12A and 12B illustrate that a user can change a Transfer Function for the left view (FIG. 12A) and the synchronization makes the right view (FIG. 12B) adapt automatically. FIGS. 13A and 13B illustrate that a user can apply a frontal cut plane on the right view (FIG. 13B) to remove the front part of the ribs, the synchronization makes the left view (FIG. 13A) adapt automatically.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed:

1. A method of electronically providing a visual comparison of rendered 3-D medical images, comprising:
providing first and second 3-D medical digital images of a patient on at least one display;
electronically altering a visualization of the first 3-D image on the at least one display; and
automatically electronically synchronizing visualization of the second 3-D image responsive to the altering of the first 3-D image.

2. A method according to claim 1, wherein the electronically altering comprises accepting user input to manipulate a visualization of the first 3-D image on the at least one display.

3. A method according to claim 1, wherein the electronically altering comprises programmatically changing a transfer function parameter to generate the altered first 3-D image and the synchronized second 3-D image.

4. A method according to claim 1, wherein the accepting user input is carried out using a graphic user interface, the method further comprising:
providing at least one 2-D image associated with each 3-D image adjacent the respective first and second 3-D images on the at least one display; and
automatically electronically updating the at least one 2-D image responsive to the electronically synchronizing step to thereby correlate the 2-D images with the altered visualization of the first and second 3-D images.

5. A method according to claim 1, wherein the providing steps are carried out so that the first and second medical images are on separate adjacent displays.

6. A method according to claim 1, wherein the providing steps are carried out so that the first and second medical images are adjacently positioned on the same display.

7. A method according to claim 1, wherein the first and second 3-D images are direct volume renderings of CT or MR images.

8. A method according to claim 1, wherein the first and second 3-D images are generated from respective digital volumetric data sets from different imaging modalities.

9. A method according to claim 2, wherein the accepting user input to manipulate the visualization of the first 3-D image comprises electronically sculpting or segmenting the first 3-D image to thereby remove portions of the volume from view.

10. A method according to claim 1, wherein the electronically altering step is automatically carried out using a predefined algorithm that generates different views of an anatomical region.

11. A method according to claim 1, wherein the electronically altering comprises at least one of the following:
rotating, zooming, panning, changing a transfer function, sculpting and segmenting the first image,
to substantially concurrently change the visualization of both the first and second images on the at least one display.

12. A method according to claim 1, wherein the electronically altering comprises zooming the first 3-D image, and wherein the electronically synchronizing comprises applying the same zooming operation substantially concurrently to the second 3-D image.

13. A method according to claim 1, wherein the electronically altering comprises changing intensity using a transfer function in the first 3-D image, and wherein the electronically synchronizing comprises applying the same transfer function operation substantially concurrently to the second 3-D image.

14. A method according to claim 1, wherein the accepting user input to manipulate the visualization of the first 3-D image comprises electronically changing a transfer function to alter intensity regions.

15. A method of providing synchronization of diagnostic images for a clinician:
displaying a first 3-D image of a target region of a patient;
displaying a second 3-D image of the same target region of the patient taken at a different time or from a different imaging modality, the second image being obtained from electronic memory, wherein the second image is displayed proximate the first image;
electronically manipulating visualization of the first 3-D image; and
automatically electronically synchronizing an altered visualization of the second 3-D image to substantially concurrently display with the same visualization as the manipulated visualization of the first 3-D image.

16. A method according to claim 15, further comprising defining a plurality of groups of 3-D images, wherein the first and second 3-D images are one of a plurality of 3-D images within a first group, and wherein the electronically synchronizing is carried out to alter all of the images within the first group of images to display with the same visualization as the manipulated visualization of the first image.

17. A method according to claim 16, wherein the electronically synchronizing is carried out to alter all of the 3-D images within a plurality of the groups to display with the same visualization as the manipulated visualization of the first image in the first group.

18. A signal processor circuit comprising a 3-D synchronization module in communication with a physician workstation, the 3-D synchronization module configured to synchronize a 3-D image of a patient on a second display with that of a corresponding 3-D image of the patient on a first display, based on a physician's interactive input of a desired view of the patient using the first display.

19. A signal processor circuit according to claim 18, wherein the 3-D synchronization module is configured to define a plurality of groups of 3-D images, wherein the corresponding 3-D images are one of a plurality of 3-D images within a first group, and wherein synchronization is applied to all the images within the first group of images on the first and second displays.

20. A signal processor circuit according to claim 18, wherein the 3-D synchronization module is configured to define a plurality of groups of 3-D images, wherein the corresponding 3-D images are one of a plurality of 3-D images within a first group, and wherein synchronization is applied to all the images within the first group of images and to at least one other defined group of images on the first and second displays.

21. A signal processor circuit comprising a 3-D synchronization module in communication with a physician workstation, the 3-D synchronization module configured to synchronize a 3-D image of a patient on a second display with that of a corresponding 3-D image of the patient on a first display, based on a sequence of views defined by a visualization algorithm corresponding to a defined diagnosis or medical condition review protocol.

22. A signal processor circuit according to claim 21, wherein the 3-D synchronization module is configured to define a plurality of groups of 3-D images, wherein the corresponding 3-D images are one of a plurality of 3-D images within a first group, and wherein synchronization is applied to all the images within the first group of images on the first and second displays.

23. A signal processor circuit according to claim 21, wherein the 3-D synchronization module is configured to define a plurality of groups of 3-D images, wherein the corresponding 3-D images are one of a plurality of 3-D images within a first group, and wherein synchronization is applied to all the images within the first group of images and to at least one other defined group of images on the first and second displays.

24. A visualization system having 3-D medical image synchronization, comprising:
a rendering system configured to generate 3-D medical images from respective digital medical volume data sets of one or more patients;
a first display in communication with the rendering system configured to display a first 3-D medical image generated by the rendering system, the first 3-D image associated with a first medical volume data set of a patient;
a second display in communication with the rendering system configured to display a corresponding second 3-D medical image of the patient, the second 3-D image associated with a second different medical volume data set of the patient;
a physician workstation comprising a graphic user interface (GUI) in communication with the first 3-D medical image on the first display to allow a physician to interactively alter the first 3-D image; and
a signal processor comprising a 3-D synchronization module in communication with the physician workstation, the 3-D synchronization module configured to synchronize the 3-D image on the second display with that of the 3-D image on the first display based on a physician's interactive input of a desired view of the patient.

25. A system according to claim 24, wherein the synchronization module is configured to programmatically (a) alter a transfer function parameter (b) segment and (c) sculpt to alter a view of the first image and substantially concurrently electronically alter a view of the second image in the same manner.

26. A system according to claim 24, wherein the first and second 3-D images are direct volume renderings of CT or MR images.

27. A system according to claim 24, wherein the first and second 3-D images are generated from respective digital volumetric data sets from different imaging modalities.

28. A system according to claim 24, wherein the GUI is configured to manipulate the visualization of the first 3-D image by electronically sculpting or segmenting the first 3-D image to thereby remove portions of the volume from view, and wherein the synchronization module is configured to do the same operation to the second 3-D image substantially concurrently.

29. A system according to claim 24, wherein the rendering system is configured to generate at least one 2-D image associated with each 3-D image adjacent the respective first and second 3-D images on the at least one display; and wherein the synchronization module is configured to automatically electronically update a view of the at least one 2-D image to thereby correlate the 2-D images with the altered visualization of the first and second 3-D images.

30. A system according to claim 24, wherein the first and second displays are configured as a unitary display screen.

31. A system according to claim 24, wherein the first and second displays are configured as a discrete displays.

32. A system according to claim 24, wherein the 3-D synchronization module is configured to define a plurality of groups of 3-D images, wherein the corresponding 3-D images are one of a plurality of 3-D images within a first group, and wherein synchronization is applied to all the images within the first group of images on the first and second displays.

33. A system according to claim 24, wherein the 3-D synchronization module is configured to define a plurality of groups of 3-D images, wherein the corresponding 3-D images are one of a plurality of 3-D images within a first group, and wherein synchronization is applied to all the images within the first group of images and to at least one other defined group of images on the first and second displays.

34. A computer program product for providing physician interactive access to patient medical volume data for generally concurrently rendering a plurality of related 3-D diagnostic medical images, the computer program product comprising:
a computer readable storage medium having computer readable program code embodied in the medium, the computer-readable program code comprising:
computer readable program code configured to generate first and second 3-D medical digital images of a patient on at least one display;
computer readable program code configured to alter a visualization of the first 3-D image on the at least one display; and
computer readable program code configured to synchronize visualization of the second 3-D image responsive to the altering of the first 3-D image.

35. A computer program product according to claim 34, wherein the computer readable program code configured to alter the visualization comprises computer readable program code that accepts user input to manipulate a visualization of the first 3-D image on the at least one display.

36. A computer program product according to claim 34, wherein the computer readable program code configured to alter the visualization comprises computer program code configured to change a transfer function parameter to generate the altered first 3-D image and the synchronized second 3-D image.

37. A computer program product according to claim 34, further comprising:
computer readable program code configured to provide at least one 2-D image associated with each 3-D image adjacent the respective first and second 3-D images on the at least one display; and
computer readable program code configured to automatically update the at least one 2-D image responsive based on the synchronized visualization of the second 3-D image to thereby correlate the 2-D images with the altered visualization of the first and second 3-D images.

38. A computer program product according to claim 37, further comprising computer readable program code configured to define a plurality of groups of 3-D images, wherein the first and second 3-D images are one of a plurality of 3-D images within a first group, wherein synchronization is applied to all the images within the first group of images on the at least one display.

39. A signal processor circuit according to claim 37, further comprising computer readable program code configured to define a plurality of groups of 3-D images, wherein the first and second 3-D images are one of a plurality of 3-D images within a first group, wherein synchronization is applied to all the images within the first group of images and to at least one other defined group of images on the first and second displays.
